(19) United States
(12) Patent Application Publication
(10) Pub. No.: US 2003/0122293 A1
(43) Pub. Date: Jul. 3, 2003

(54) Variable rate multi-arc composite leaf spring assembly

(75) Inventors: Junaid Akhtar, Westland, MI (US); Giovanni Greco, Canton, MI (US)

Correspondence Address: Steven L. Oberholtzer, BRINKS HOFER GILSON & LIONE, P. O. Box 10395, Chicago, IL, 60610, US

(73) Assignee: VISTEON GLOBAL TECHNOLOGIES, INC.

(21) Appl. No.: 10/034,574

(22) Filed: Dec. 27, 2001

(51) Int. Cl. F16F 1/18; B60G 11/02

(52) U.S. Cl. 267/36.1

(57) ABSTRACT

In one aspect of the invention, a variable rate multi-arc leaf spring assembly is provided. The assembly includes a main leaf spring that is constructed of a composite material and defines a central arc portion having a first radius and at least one peripheral arc portion having a second radius not equal to said first radius. The main leaf spring provides a continuous non-linear variable spring deformation rate.

### FIELD OF THE INVENTION

The present invention relates generally to a composite leaf spring for automobiles. More particularly, it relates to an automotive multi-arc composite leaf spring assembly having a continuous non-linear variable spring rate response.

### BACKGROUND

Automotive suspension systems commonly utilize leaf springs to support and cushion a vehicle and its passengers. Conventional known steel leaf springs utilize multiple secondary steel leaves of decreasing lengths secured below and parallel to a main steel leaf to provide a variable spring rate under increasing load conditions. A variable non-linear spring rate is desirable because it can help achieve a smooth and comfortable vehicle ride. For example, a low spring rate offering a soft ride may be desirable under normal driving conditions. As the load applied to a vehicle is increased, it may be desirable for the spring to become increasingly stiffer in order to carry the heavier load and to prevent undesirably large spring deflections.

Steel leaf springs require a multi-leaf design because a single thick steel leaf is too stiff for automotive use. While multi-leaf steel spring designs do offer a variable response rate, the transition from a low or soft spring rate to a harder or higher spring rate may be abrupt or discontinuous as the main leaf deflects into sudden contact with secondary leaves. Such sudden changes in spring rate can result in a harsh vehicle ride. Furthermore, the large weight and bulk of steel leaf springs limit their potential use and can contribute to increased fuel inefficiencies.

The use of composite materials in the manufacture of composite leaf springs offers much lighter and more compact designs. In order to produce composite leaf springs with different predetermined spring rates, a known method replaces some of the glass fiber content in a composite spring with fibers having a lower modulus of elasticity than glass. By varying the percentage content of the glass and other fibers, the spring rate of such a hybrid composite leaf spring can be controlled during manufacture. However, this method requires a complex manufacturing process to produce springs having a homogenous structure. A homogenous structure that evenly distributes the different modulus fibers and the glass fibers throughout a resin matrix is necessary to achieve uniform stress distribution and to avoid catastrophic operational failure due to delamination. Also, such springs do not have variable spring rates and do not provide a smooth ride during normal and high load driving conditions.

In another known dual rate leaf spring construction, a shorter and stiffer secondary spring having elastomeric pads mounted on each end is secured beneath and parallel to a main composite leaf spring such that the pads are spaced apart from the main spring. Once a heavy load causes the main composite leaf spring to deflect downwardly into contact with the pads, the secondary spring helps to carry a portion of the load and the entire leaf spring construction responds with an increased spring rate. However, the spring rate transition from soft to hard range for this dual spring rate design is again abrupt. Also, the physical constraints of mounting pads on a secondary spring below the main spring may limit the use of this dual spring rate design in certain applications.

Alternatively, a known variable rate leaf spring design utilizes a resilient bumper having a low spring rate on initial loading and a higher spring rate for increased loading. The bumper is mounted on the frame of a vehicle above and out of contact with a composite leaf spring. The ends of the spring are connected to the vehicle frame and a vehicle axle is mounted to the central portion of the spring. During loading, the bumper is engaged by the spring to provide a higher spring rate. However, the performance characteristics of this spring structure are often undesirable as the spring comes into sudden contact with the bumper.

In the area of automotive composite leaf springs, there continues to be a need for a leaf spring design that provides a continuous non-linear variable spring rate for improved vehicle ride quality and offers increased ease of manufacturing.

### SUMMARY

In one aspect of the invention, a variable rate multi-arc leaf spring assembly is provided. The assembly includes a main leaf spring that is constructed of a composite material and defines a central arc portion having a first radius and at least one peripheral arc portion having a second radius not equal to said first radius. The main leaf spring provides a continuous non-linear variable spring deformation rate.

In another aspect of the invention, the variable rate multi-arc leaf spring assembly includes a main leaf spring that is constructed of a composite material and defines a central arc portion having a first radius and at least one peripheral arc portion having a second radius not equal to the first radius. The main leaf spring provides a continuous non-linear variable spring deformation rate. The assembly further includes a load plate adjacent the leaf spring. The load plate continuously engages said leaf spring during a predetermined set of payload conditions to enhance the continuous non-linear variable spring deformation rate of the main leaf spring.

In yet another aspect of the invention, the variable rate multi-arc leaf spring assembly includes a main leaf spring that is constructed of a composite material and defines a plurality of arced sections integrated along length of the main leaf spring. At least two of said sections have different spring rates. The main leaf spring provides a continuous non-linear variable spring deformation rate.

In another aspect of the invention, a method of achieving a continuous non-linear variable spring deformation rate for a multi-arc leaf spring assembly is provided. The method includes providing a main leaf spring constructed of a composite material. The main leaf spring defines a central arc portion having a first radius and at least one peripheral arc portion connected with the central arc portion and having a second radius not equal to the first radius. The method also includes providing a load plate adjacent the leaf spring. The method further includes applying a downward force to the main leaf spring to achieve a soft spring rate. The method also includes applying an increased downward force to the main leaf spring. The main leaf spring progressively and continuously engages the load plate to achieve a hard spring rate and a smooth transition from the soft spring rate to the hard spring rate.

### BRIEF DESCRIPTION OF THE DRAWINGS

FIG. 1 is a perspective view of a variable rate multi-arc spring assembly in accordance with the present invention, showing the spring assembly under no-load conditions;

FIG. 2 is a side view of the variable rate multi-arc spring assembly of FIG. 1;

FIG. 3 is a sectional view of the variable rate multi-arc spring assembly of FIG. 1;

FIG. 4 is an exploded view of the variable rate multi-arc spring assembly of FIG. 1;

FIG. 5 is an enlarged fragmentary view showing an integral mounting end of the variable rate multi-arc spring assembly of FIG. 1;

FIG. 6 is another side view of the variable rate multi-arc spring assembly of FIG. 1, showing a main leaf spring deflected into contact with a load plate under load conditions;

FIG. 7 is a side view of another variable rate multi-arc spring assembly in accordance with the present invention;

FIG. 8 is a graph showing a continuous non-linear variable spring deformation rate of the variable rate multi-arc spring assembly of FIG. 1; and

FIG. 9 is a flowchart for a method of achieving a continuous non-linear variable spring deformation rate in accordance with the present invention.

### DETAILED DESCRIPTION OF THE PREFERRED EMBODIMENTS

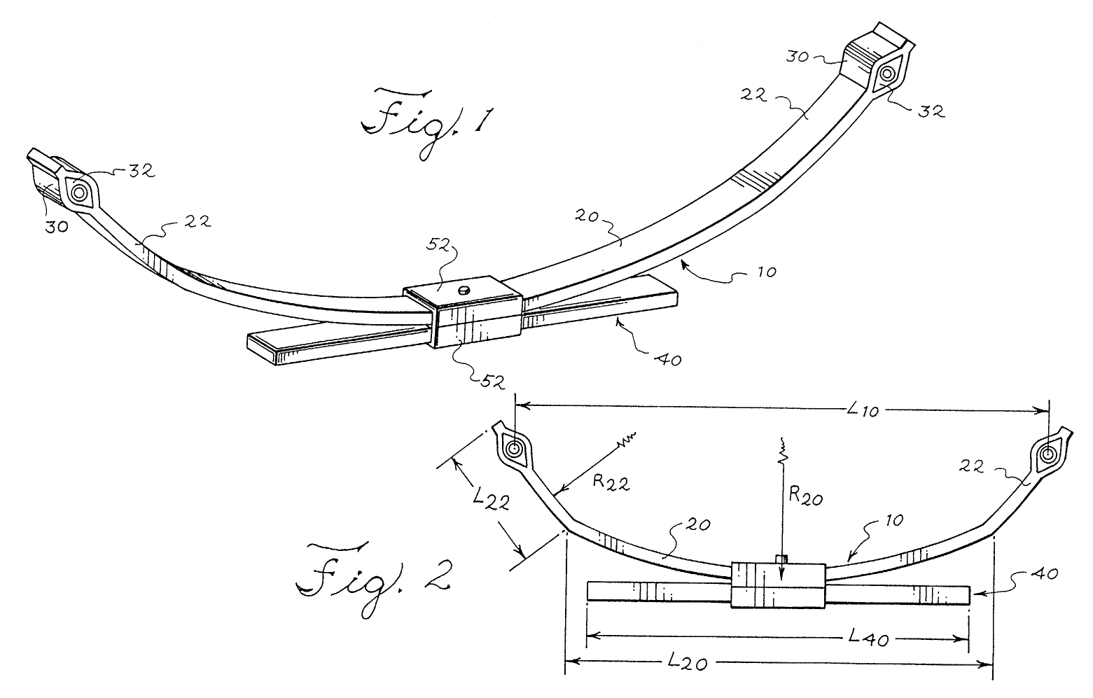

Referring now to the drawings, FIGS. 1-5 illustrate a variable rate multi-arc leaf spring assembly for automotive use made according to the present invention. The leaf spring assembly includes a main leaf spring 10 and a load plate 40. The embodiment also includes improved attaching means in the form of urethane brackets 52.

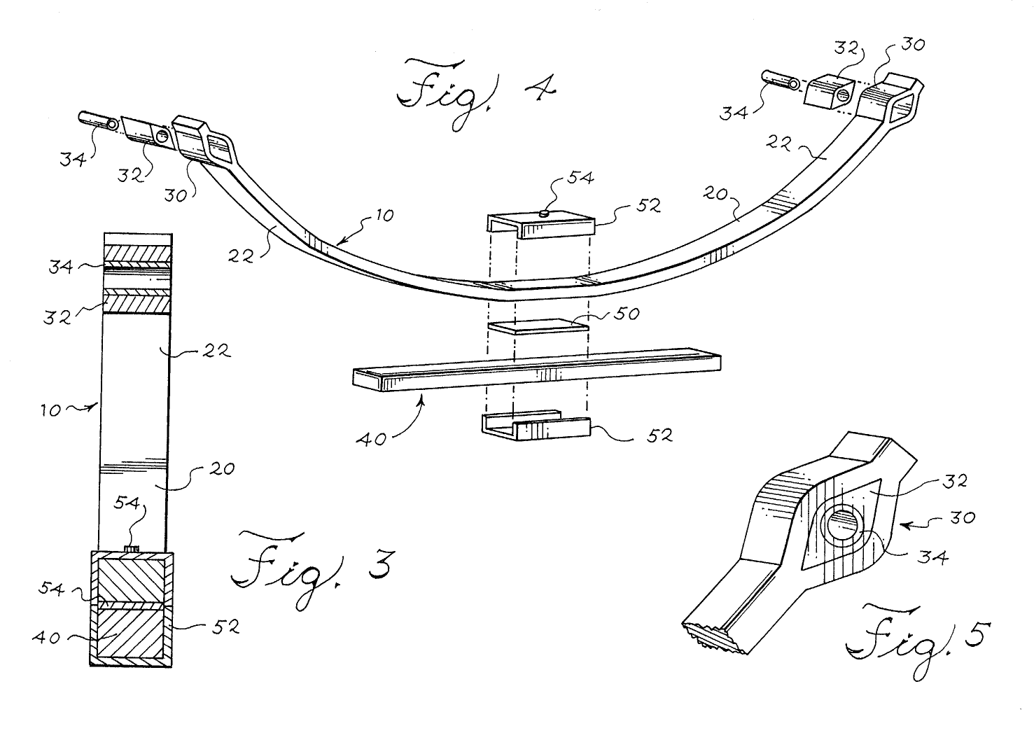

The main leaf spring 10 is curved generally upwardly and has a central arc portion 20, a pair of matching peripheral arc portions 22 and a pair of integral mounting ends 30 as shown in FIG. 1. Each peripheral arc portion 22 is joined with an opposing end of the central arc portion 20 and with an integral mounting end 30 to form a unitary single leaf construction for the main leaf spring 10. Both the central arc portion 20 and the peripheral arc portions 22 are curved generally upwardly. In one embodiment, each peripheral arc portion 22 has a radius R₂₂ that is preferably greater than the radius R₂₀ of the central arc portion 20 and a length L₂₂ that is preferably shorter than the length L₂₀ of the central arc portion, as shown in FIG. 2. For example, in one embodiment of the variable rate multi-arc spring leaf assembly, the central arc portion 20 of the main leaf spring 10 has a radius R₂₀ of 980 mm and a circumferential length L₂₀ of 932 mm, while each peripheral arc portion 22 has a radius R₂₂ of 1130 mm and a circumferential length L₂₂ of 210 mm. It should be understood that these dimensions are meant to be illustrative, rather than limiting. Other radii and lengths for the arc portions 20 and 22 would also work depending on the desired spring rate for the main leaf spring. For instance, other embodiments may include central arcs having shorter lengths than the peripheral arc portions, or other geometries in accordance with the desired spring rate.

The technique of blending multiple arc portions 20 and 22 having different radii and different lengths within the main leaf spring 10 produces a continuous non-linear variable spring rate for the main leaf spring even in the absence of additional leaves, pads or other contact surfaces. Furthermore, in order to provide an improved vehicle ride, the spring rate of a multi-arc main leaf spring 10 made according to the present invention can be manipulated by changing the geometry of the spring, more particularly by varying the radius R₂₀ and length L₂₀ of the central arc portion 20 and the radii R₂₂ and length L₂₂ of the peripheral arc portions 22. In addition, the blending of multiple arc geometries within the main leaf spring 10 helps to distribute stress evenly throughout the main leaf by providing smooth, frictionless transitions between sections having different stiffnesses. Distributing stress evenly helps to prevent operational failure of the main leaf spring due to delamination caused by non-uniform stress.

As seen in FIG. 3, the main leaf spring 10 is generally rectangular in cross section. Preferably, the main leaf spring 10 has a uniform cross sectional area throughout its entire length, including the central arc portion 20 and peripheral arc portions 22. This construction offers increased ease of manufacturing. Those skilled in the art will readily recognize that the cross sectional area of the main leaf spring 10 may also be defined by other shapes, such as various trapezoidal shapes. Similarly, it is not necessary for the main leaf spring 10 to have a uniform cross sectional area throughout its entire length. For example, the main leaf spring may include peripheral arc portions 22 that are tapered toward one end.

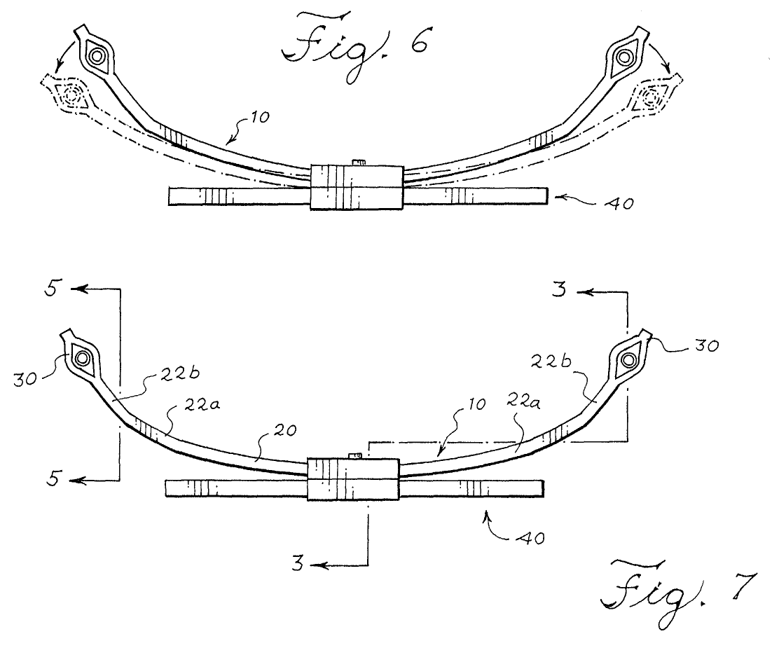

Referring next to FIGS. 4-5, a pair of integral mounting ends 30 is shown. Each integral mounting end 30 defines an opening for receiving a mounting eyelet 32 that is provided with an out-of-mold metallic insert 34, the entire arrangement forming an integral part of the main leaf spring 10 as described below. The pair of integral mounting ends 30 is used to attach the main leaf spring to a loading structure, for example, a vehicle frame.

The main leaf spring 10 shown in FIGS. 1-5 is formed of a composite material, preferably a fiber-reinforced resin. More preferably, a unidirectional (UD) tape is utilized which consists of glass fibers that are pre-impregnated in a M10 epoxy matrix with a 50% fiber volume fraction and are oriented in one direction. Such a pre-peg tape is available from Hexcel Corp. of Dublin, Calif., USA. Those skilled in the art will readily recognize that other materials may be used for the fibers and the resin depending on the mechanical and environmental operating limits placed on the spring. In a preferred embodiment, the main leaf spring 10 is formed from strips of the UD tape material using a compression molding process. More particularly, a predetermined number of UD tape strips are wrapped around the mounting eyelet 32 at room temperature. An initial composite lay-up of the spring is placed into a preheated mold at a temperature of from about 135 degrees Celsius to about 150 degrees Celsius for about 30 minutes. The lay-up then is compressed in the mold cavity using a press closing cycle of about 8 minutes until sealed. It is then cured for about 10 minutes in an oven at a temperature of from about 100 degrees Celsius to about 120 degrees Celsius, making sure that the temperature of the main leaf spring does not reach 150 degrees Celsius or it will exotherm. Finally, the main leaf spring is de-molded while it is still generally hot.

Those skilled in that art will recognize that other fibers or resins may also be used, for instance polyester or vinyl-ester resins. The volume fraction of fiber in the composite may be increased or decreased to increase or decrease the stiffness of the main leaf spring 10 or a portion thereof. While unidirectional fibers are preferred in some embodiments, other embodiments may use layers of 90 degree tape or cross-play tape at 45 degrees or other angles such as 30 degrees or 60 degrees in order to tailor the strength of modulus properties of the composite spring.

In order to enhance the continuous non-linear variable spring rate for the main leaf spring 10 and assist in providing a desired spring rate response, a load plate 40 is provided in the present embodiment, as shown FIGS. 1-4. The load plate 40 is adapted to engage the main leaf spring 10 under load conditions. As shown in FIGS. 1-2, the load plate 40 is disposed beneath the main leaf spring 10, preferably beneath the central arc portion 20 and more preferably at a location such that the midpoint of the load plate 40 is spaced vertically beneath the midpoint of the central arc portion 20.

In the present embodiment, the load plate 40 is preferably constructed of the same composite material as the main leaf spring. As desired, other embodiments may achieve more stiffness or less in the load plate by varying the fiber volume fraction in the load plate. Also, in the present embodiment, the load plate 40 preferably has a planar upper surface with a length L₄₀ that is generally shorter than the eye-to-eye length L₁₀ of the main leaf spring. For example, the eye-to-eye length L₁₀ of the main leaf spring 10 may be approximately 1205 mm while the length L₄₀ of load plate 40 is approximately 600 mm, as shown in FIG. 2. In addition, the load plate 40 preferably has a generally rectangular uniform cross sectional area throughout its entire length to simplify the manufacturing process, as shown in FIG. 3.

However, those skilled in the art will recognize that these dimensions for the load plate 40 are only illustrative. It should be understood that the geometry of the load plate may vary according to the desired spring rate response for the spring and load plate assembly. For example, it is not necessary for the cross sectional area of the load plate 40 to have the same dimensions as the cross sectional area of the main leaf spring 10. Furthermore, the cross sectional area of the load plate 40 may be non-uniform across the length of the load plate, including tapered portions thereof. The load plate 40 may also have a non-planar upper surface that engages the main leaf spring 10 as described below, including a surface curving upwardly toward the ends of the main leaf spring 10 having a radius larger than the radius of any arc portion 20 and 22 defining the main leaf spring 10.

In order to form a variable rate multi-arc leaf spring assembly according to the present invention, the main leaf spring 10 and the load plate 40 are preferably adhesively bonded together using a pair of urethane brackets 52 that wrap around the main leaf spring 10 and the load plate 40, as shown in FIGS. 1-4. The urethane brackets 52 may have a locating knob 54 for mounting the leaf spring assembly on a vehicle axle (not shown). Furthermore, an intermediary member 50 is preferably disposed between the main leaf spring 10 and the load plate 40, as shown in FIG. 4, to enhance bonding and prevent slip between the main leaf spring and the load plate. In one embodiment, the intermediary member 50 consists of a layer of urethane, but other suitable strong materials such as an elastomeric or plastic material may be used instead.

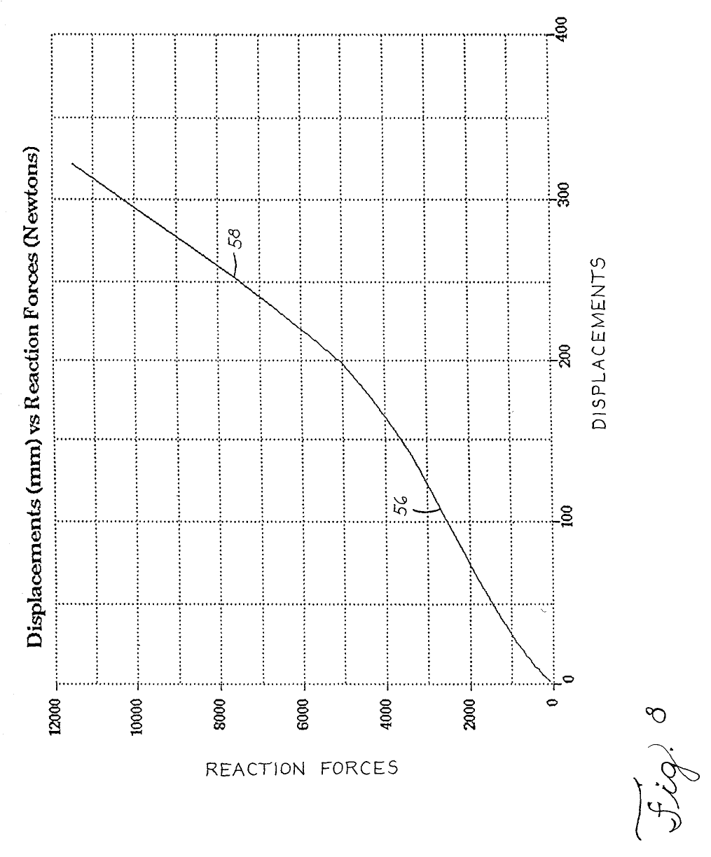

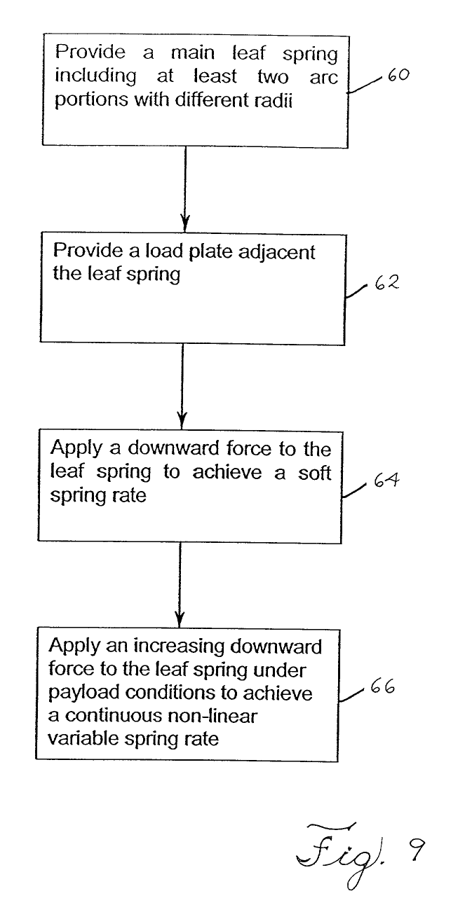

Under empty payload conditions, including no load and curb load conditions, the main leaf spring 10 transfers no load to the load plate 40. Therefore, the intermediary member 50 causes the main leaf spring 10 to be spaced out of direct contact with the load plate 40 under empty payload conditions. Loading and contact between the main leaf spring and the load plate starts when a payload is applied, causing the main leaf spring to deflect into contact with the load plate, as shown in FIG. 6. The contact length between the main leaf spring and the load plate generally increases with higher loads. The combination of the main leaf spring 10 and the load plate 40 then provides a desired continuous non-linear variable spring rate, as shown in FIG. 8. This response features a first region with a soft range response 56 under curb load and normal load conditions. The response also features a smooth transition from the soft range response 56 to a stiffer response 58 as the load and spring deflection increases.

Those skilled in the art will readily recognize that a main leaf spring made according to the present invention is not limited to one pair of peripheral arc portions. For example, another preferred embodiment of the invention utilizes a first pair of peripheral arc portions 22a and a second pair of peripheral arc portions 22b, as shown in FIG. 7. Preferably, both pairs are disposed symmetrically about the central arc portion 20, with the peripheral arc portions 22a being connected to opposing ends of central arc portion 20 and the peripheral arc portions 22b being connected to the ends of the leading peripheral arc portions 22a and to a pair of integral mounting ends 30. More particularly, peripheral arc portions 22a have the same radius and the same length. The peripheral arc portions 22b are likewise identical to each other within manufacturing tolerances. But the peripheral arc portions 22a have a generally larger radius than the peripheral arc portions 22b. In addition to different pairs of matching peripheral arc portions, those skilled in the art will also recognize that individual peripheral arc portions having different radii and lengths may be joined in an asymmetric arrangement about a central arc portion.

Another embodiment of the invention is a method of achieving a continuous non-linear variable spring deformation rate for a multi-arc leaf spring assembly, as shown in FIG. 9. The method includes the step 60 of providing a main leaf spring constructed of a composite material. The main leaf spring defines a central arc portion with a first radius. The main leaf spring also defines at least one peripheral arc portion having a second radius not equal to the first radius and connected with the central arc portion. The method also includes the step 62 of providing a load plate with an upper surface adjacent said leaf spring. The method further includes the step 64 of applying a downward force to the main leaf spring to achieve a soft spring rate. The method also includes a step 66 of applying an increasing downward force to the main leaf spring under payload conditions such that the main leaf spring progressively and continuously engages the load plate to achieve a stiffer response. The method provides a smooth transition from the soft range response to the hard range response.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivlents thereof.

We claim:

1. A variable rate multi-arc leaf spring assembly comprising:
a main leaf spring constructed of a composite material, said main leaf spring defining a central arc portion having a first radius and at least one peripheral arc portion having a second radius not equal to said first radius,
wherein said main leaf spring provides a continuous non-linear variable spring deformation rate.

2. The variable rate multi-arc leaf spring assembly of claim 1 wherein said composite material consists of a fiber-reinforced resin.

3. The variable rate multi-arc leaf spring assembly of claim 1 wherein said main leaf spring defines a uniform cross-sectional area throughout its length.

4. The variable rate multi-arc leaf spring assembly of claim 1 wherein said main leaf spring further includes at least one integral mounting end connected with said at least one peripheral arc portion, said at least one mounting end adapted to be connected to a loading structure.

5. The variable rate multi-arc leaf spring assembly of claim 4 wherein said at least one integral mounting end comprises a mounting eyelet.

6. The variable rate multi-arc leaf spring assembly of claim 5 wherein said a mounting eyelet includes a metallic insert for installation.

7. The variable rate multi-arc leaf spring assembly of claim 1 further comprising a load plate, said load plate adjacent said leaf spring, wherein said load plate continuously engages said leaf spring during a predetermined set of payload conditions to enhance said continuous non-linear variable spring deformation rate.

8. The variable rate multi-arc leaf spring assembly of claim 7 wherein said load plate is constructed of same said composite material as said main leaf spring.

9. The variable rate multi-arc leaf spring assembly of claim 7 wherein said load plate defines a uniform cross-sectional area throughout its length.

10. The variable rate multi-arc leaf spring assembly of claim 7 further comprising an intermediary member spaced between said leaf spring and said load plate.

11. The variable rate multi-arc leaf spring assembly of claim 10 wherein said intermediary member is constructed of urethane.

12. A variable rate multi-arc leaf spring assembly comprising:
a main leaf spring constructed of a composite material, said main leaf spring defining a central arc portion having a first radius and at least one peripheral arc portion having a second radius not equal to said first radius, wherein said main leaf spring provides a continuous non-linear variable spring deformation rate; and
a load plate, said load plate adjacent said leaf spring, wherein said load plate continuously engages said leaf spring during a predetermined set of payload conditions to enhance said continuous non-linear variable spring deformation rate.

13. The variable rate multi-arc leaf spring assembly of claim 12 wherein said composite material consists of a fiber-reinforced resin.

14. The variable rate multi-arc leaf spring assembly of claim 12 wherein said main leaf spring defines a uniform cross-sectional area throughout its length.

15. The variable rate multi-arc leaf spring assembly of claim 12 wherein said main leaf spring further includes at least one integral mounting end connected with said at least one peripheral arc portion, said at least one mounting end adapted to be connected to a loading structure.

16. The variable rate multi-arc leaf spring assembly of claim 15 wherein said at least one integral mounting end comprises a mounting eyelet.

17. The variable rate multi-arc leaf spring assembly of claim 16 wherein said a mounting eyelet includes a metallic insert for installation.

18. The variable rate multi-arc leaf spring assembly of claim 12 wherein said load plate is constructed of same said composite material as said main leaf spring.

19. The variable rate multi-arc leaf spring assembly of claim 12 wherein said load plate defines a uniform cross-sectional area throughout its length.

20. The variable rate multi-arc leaf spring assembly of claim 12 further comprising an intermediary member spaced between said leaf spring and said load plate.

21. The variable rate multi-arc leaf spring assembly of claim 20 wherein said intermediary member is constructed of urethane.

22. A variable rate multi-arc leaf spring assembly comprising:
a main leaf spring constructed of a composite material, said main leaf spring defining a plurality of arced sections integrated along length of said main leaf spring, at least two of said sections having different spring rates;
wherein said main leaf spring provides a continuous non-linear variable spring deformation rate.

23. The variable rate multi-arc leaf spring assembly of claim 22 wherein said main leaf spring further includes at least one integral mounting end connected with at least one of said arced sections, said at least one mounting end adapted to be connected to a loading structure.

24. The variable rate multi-arc leaf spring assembly of claim 23 wherein said at least one integral mounting end comprises a mounting eyelet.

25. The variable rate multi-arc leaf spring assembly of claim 24 wherein said a mounting eyelet includes a metallic insert for installation.

26. The variable rate multi-arc leaf spring assembly of claim 22 further comprising a load plate, said load plate adjacent said leaf spring, wherein said load plate continuously engages said leaf spring during a predetermined set of payload conditions to enhance said continuous nonlinear variable spring deformation rate.

27. The variable rate multi-arc leaf spring assembly of claim 26 further comprising an intermediary member spaced between said leaf spring and said load plate.

28. A method of achieving a continuous non-linear variable spring deformation rate for a multi-arc leaf spring assembly comprising:
providing a main leaf spring constructed of a composite material, said main leaf spring defining a central arc portion having a first radius and at least one peripheral arc portion connected with said central arc portion and having a second radius not equal to said first radius;
providing a load plate, said load plate adjacent said leaf spring;
applying a downward force to said main leaf spring to achieve a soft spring rate; and
applying an increased downward force to said main leaf spring, wherein said main leaf spring progressively and continuously engages said load plate to achieve a hard spring rate and a smooth transition from said soft spring rate to said hard spring rate.

29. The method of claim 28 wherein said main leaf spring further includes at least one integral mounting end connected with said at least one peripheral arc portion, said at least one mounting end adapted to be connected to a loading structure.

30. The method of claim 28 further comprising the method of separating said main leaf spring from said load plate under empty payload conditions with an intermediary member.
